(19) United States
(12) Patent Application Publication
(10) Pub. No.: US 2009/0193106 A1
(43) Pub. Date: Jul. 30, 2009

(54) SYSTEM AND METHOD FOR MANAGING MESSAGE TRANSPORT IN A VIRTUAL ENVIRONMENT

(76) Inventors: Christophe Bouten, Antwerpen (BE); Kurt Tuypens, Asse (BE); Ari Weinstock, Brooklyn, NY (US); Evan Holod, Forest Hills, NY (US)

Correspondence Address: DARBY & DARBY P.C., P.O. BOX 770, Church Street Station, New York, NY, 10008-0770, US

(21) Appl. No.: 12/019,555

(22) Filed: Jan. 24, 2008

(51) Int. Cl. G06F 15/173

(52) U.S. Cl. 709/223

(57) ABSTRACT

A system and method for communicating through a network wherein a user may write a message that is released into a virtual environment. The message must be selected by a second user to be read, but the second user does not know the content of the message until the message is selected to be read. The travel of the message through the virtual environment may be based on travel of a message in a bottle through waterways such as rivers, lakes or oceans. After the message is selected and read, the second user may elect to contact the sender to engage in further communications.

### FIELD OF INVENTION

The present invention relates generally to an online communication system for children that enables random contact between different users. More specifically, a first user with a location on a geographic map of a virtual environment creates a message that is put into a virtual “bottle” and cast into waterways within the geographic map. A second user has the option of selecting the virtual bottle when it is within a predetermined distance from the location of the second user on the geographic map. The two users are then able to communicate within the virtual environment through the online communication system.

### BACKGROUND OF THE INVENTION

The Internet provides numerous ways of connecting with people in different locations. There are many websites that enable contact between people with similar interests. Most of these websites are geared for adult users that are seeking specific contacts where the user initiates the contact based on various information entered by other persons. An example of this is on-line dating websites. Another example is through sites that permit the posting of various content, such as personal information or multimedia content. These sites provide a medium for people to share information among known social contacts or to express their ideas in the expectation that interested people will make efforts at making contact. Most of these types of websites are directed towards adults, and do not provide an entertainment value that is geared towards children.

For children, contact with people in distant places can be exciting. The opportunity to converse with a “pen pal” can provide a unique learning experience. However, identifying suitable persons with which to correspond is one of the difficulties with setting up a pen pal relationship. Simply randomly assigning pen pals lacks entertainment value and may lead to pairing of individuals who lack common interests.

A number of websites such as Webkinz, Neopets and Club Penguin provide an online entertainment experience for children. In the Webkinz website, a child logs onto the website using an activation code that is purchased in conjunction with a toy stuffed animal. The child would then have various activities related to the care of a virtual representation of the toy stuffed animal. Among the activities is an opportunity to correspond with other children either individually or in groups. The communications are largely connected with the virtual representation of the toy stuffed animal, but lack an entertainment value in the method that the communication is set up between individuals.

In popular fiction, a lone castaway on a deserted island would write a message on a piece of paper, insert the paper into a bottle, seal the top and then cast the bottle into the ocean. The castaway would then hope that someone would read the “message in a bottle” and perhaps respond to the message. This method of communication is random in nature since the sender does not know if or when the message would be read by another person. However, this method of communication provides entertainment in the act of sending the message because of the uncertainty of if, when and where the message will be picked up and read. In addition, there is significant entertainment value in reading the messages from others because of the discovery aspect of reading a message from a complete stranger that has never been read by anyone before. This classic approach has the bottle bobbing and subject to the force of the rivers and oceans, whereas the Internet does not operate this way.

It is in light of the foregoing that the current invention is contemplated.

### SUMMARY OF THE INVENTION

The present invention relates to an online communication system that enables communication between different persons based on a programmed environment to implement the concept of putting a message in a bottle and casting it into a waterway in a virtual world in which it could be picked up and read depending on where the bottle travels in the virtual world.

In one aspect of the communication system, a user is provided with a home location on a virtual geographic map. This home location can be based on personal information entered by the user, such as the city within which the person lives. The geographic map may include various rivers, lakes, oceans and other waterways. The user writes a message that is to be placed within a bottle, the bottle is then “thrown” into an adjacent waterway. The bottle then travels within the various waterways. When the bottle is adjacent to the location of another user, the other user is provided with the option of reading the message contained within the bottle. If the other user reads the message, the other user has the option of contacting the original sender and engaging in further conversations. In one embodiment, the users can become “bottle mates” and the system will show an indication that “bottle mates” are online at the same time, through the use of, for example, avatars. In this embodiment, the system can show a virtual representation of the bottle mate on the user's home beach. The user's home beach is a customizable area that is provided for the user as an entryway portal to the various activities.

In another aspect of the system, the user can track the progress of their bottle throughout the virtual world. This provides feedback to the user. The progress of the bottle can be changed in various ways. For instance, a storm can cause the bottle to progress faster or a seagull could pick-up the bottle and drop it off in a different location, such as a different river. Similar random events can occur to add variation into the system.

In another aspect of the system, the user is required to enter an authorization code to first enter into the virtual world. The authorization code would permit the user to write and send one message, and permit the user to read one message. To obtain the authorization code, the user may be required to purchase a consumer product within which the authorization code is located. For example, a food safe paper containing an authorization code can be contained within a confectionary baby bottle, such as Baby Bottle Pop Candy sold by The Topps Company. The food safe paper also alternatively contain other messages to the purchaser of the product. As one instance, the paper can contain a “message from Santa.” This concept does not necessarily need to be connected to the online virtual world, but may be. As an example, the food safe paper may contain a code that, when entered into the virtual world, activates additional special features. Such special features can be a message from Santa, additional game plays or additional information about the virtual world that cannot be otherwise accessed. The system can also provide a virtual representation of the consumer product, and it can be used to contain the message that is cast into the waterways of the virtual world. The system can provide opportunities for the user to customize the bottles as they appear in the virtual world. The bottles can be individualized so that other users can judge whether a particular bottle should be read or not based on the customization of the bottle.

Virtual points or awards can be provided to the user depending on the distance that the bottle travels. In another aspect of the system, the user can be required to perform some task so that the bottle will keep on traveling through the virtual world. For instance, when the bottle reaches a border between states, the user can be required to play and complete an online game for the bottle to pass the border. As another example, a user can be provided with rewards for successfully completing games, engaging in on-line activities, having their bottle travel a certain number of miles (bottlemiles) or the like. For instance, for successfully completing a spelling-related task, a user can be provided with additional bottles for sending messages into the virtual world or additional opportunities to read existing bottles. Alternatively, rewards can also such things as a coupon redeemable for additional actual products, which may include additional access codes. If the user obtains additional bottles (either through purchase or through rewards), the user can send additional bottles into the virtual world to be picked up by other users.

If a bottle is not selected to be read, it will continue to travel throughout the virtual world. As one example, if the bottle travels throughout the world and returns to the sender, the user can be provided with additional rewards or acknowledgements. For instance, the bottle can be placed within a “hall of fame.”

One of the benefits of this communication system is that the user is provided with the excitement of placing a message into a bottle without knowing when, where or if the bottle will ever be chosen and read by another user. The user can track the progress of the bottle over time, play games and earn rewards. The rewards can be redeemed for more bottles or the like. If the bottle is selected, then the user can converse on-line with their bottle mates, often persons located in different geographic locations.

These and other benefits are described more specifically as set forth below.

### BRIEF DESCRIPTION OF THE DRAWINGS

The present invention is specifically disclosed in the detailed description set forth herein with respect to the accompanying drawings, wherein:

FIG. 1 is a system diagram of a network within which the invention can be implemented.

FIG. 2 shows the structure of a network device that may be used in the system for implementing the invention.

FIG. 3 is a block diagram showing the relationship between different processes a user of the system can select in one embodiment of the system.

FIG. 4 illustrates one embodiment of an entry portal for the user of the system.

FIG. 5 is a process flow chart for registering new users or logging in existing users of the system.

FIGS. 6 and 6A are a representation of a consumer product that contains within it an authorization code for use with the invention.

FIG. 7 is a process flow chart for the selectable options presented to the user after registration or logging in.

FIG. 8 is one embodiment of the user personalized beach page that has selectable options for using the communication system.

FIG. 9 is a process flow chart for when a user of the system writes a message.

FIG. 10 is a process flow chart for when a user of the system reads a message sent by another user.

FIG. 11 is a process flow chart for assigning the bottle with a location within the geographic region.

FIG. 12 illustrates one embodiment of the geographic map with locations of various bottles.

FIG. 13. shows an example of a data table for use in the invention.

### DETAILED DESCRIPTION

Certain embodiments of the invention are described more specifically with reference to the accompanying drawings. The invention may be embodied in many different forms and should not be construed as limited to the embodiments described herein. Rather, the embodiments may take different forms, such as entirely implemented through hardware, through hardware combined with software or entirely through software. Throughout this description, the various embodiments are not intended to be limiting unless so specified. References to one embodiment or another embodiment are intended to be interchangeable such that aspects of different embodiments may be combined in various ways to implement the disclosed invention.

### Environment for Implementing the Invention

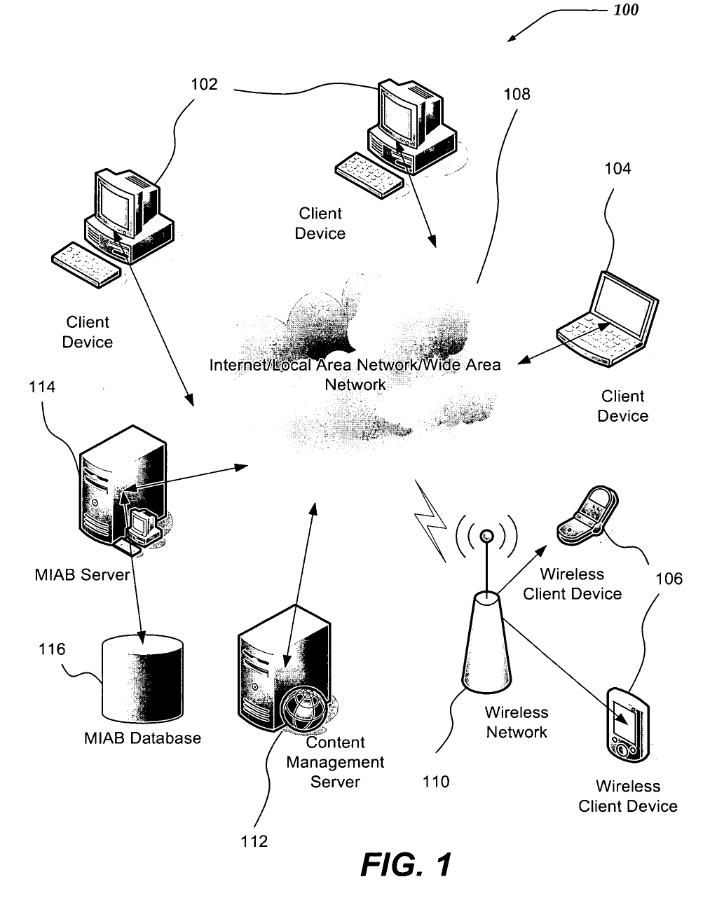

Network 100 is shown in FIG. 1. Not all of the components are required for any given implementation of the invention, and variations in the arrangement and types of components may be made without departing from the scope of the invention. As shown in FIG. 1, client devices 102, 104 can consist of personal computers, laptop computers and any other device capable of establishing a communication link with Internet/Local Area Network/Wide Area Network 108 through a wired communications medium. Client devices 102, 104 may be linked to other Wide Area Networks and/or Local Area Networks. Client devices may also consist of wireless client devices 106 such as cell phones, personal digital assistants, laptop computers, hand held computers and similar devices. Wireless client devices 106 are connected to Internet/Local Area Network/Wide Area Network 108 through wireless network 110. The client devices are capable of identifying their location to other devices within the various networks. For example, cellular phones can identify themselves through Mobile Identification Numbers, Electronic Serial Numbers or mobile phone numbers. Computer devices can identify themselves through network addresses or other device identifiers. The identifier information may be included in messages or information sent to other devices within the various networks so that communications can take place through the network between the devices. Such communication can take place through known communication methods such as Short Messaging Service (SMS), Multimedia Message Service (MMS), Instant Messaging (IM), Internet Relay Chat (IRC), Jabber or the like. Any suitable protocol or method of communication can be used to implement the current invention.

The client devices may include application programs that send and receive web-pages, web-based messages, data, packets having content for updating graphics on a client device and the like. The application programs may be browsers and associated programs that send, receive and display graphics, text, sound and multimedia. The client devices may have operating systems that enable the application programs, and use various protocols/languages to enable the web-based application programs such as Handheld Device Markup Language (HDML), HyperText Markup Language (HTML), JavaScript, eXtensible Markup Language (XML), and the like.

The various networks may also include network devices that provide content to users such as content management server 112. These devices are capable of sending and receiving text, photographs, web pages, multimedia information, and the like. These network devices provide substance of interest to users of Internet/Local Area Network/Wide Area Network 108.

Internet/local area server/wide area server 108 can couple Message In A Bottle Server (MIAB Server) 114 to other computing devices including client devices 102, 104, wireless client devices 106 and Content Management Server 112. MIAB Server 114 can be configured to provide web pages with sufficient detail to create a virtual world to users of client devices 102, 104 and 106. MIAB Server 114 can draw content from Content Management Server 112 in implementing this invention. Internet/local area server/wide area server 108 can use any form of computer readable media for communicating with the various electronic devices. The connections between the electronic devices can be through twisted pair, coax, fiber optics, satellite, carrier waves or any other commonly known medium. The communications can take place through routers and other networking equipment in a conventional manner. Further, the communications can have dynamic architectures and use any of a number of known protocols for communication. However, such communications differ from the inventive message handling within a virtual environment as described further below.

MIAB Server 114 may include any type of computing device capable of networking with Internet/Local Area Network/Wide Area Network 108 and enabled to manage a web site (a collection of web pages) and communication with and between users of the web site. In one embodiment, MIAB Server is connected with MIAB Database which stores data used by or received from users of the MIAB Server. In another embodiment, the data storage takes place within MIAB Server 114.

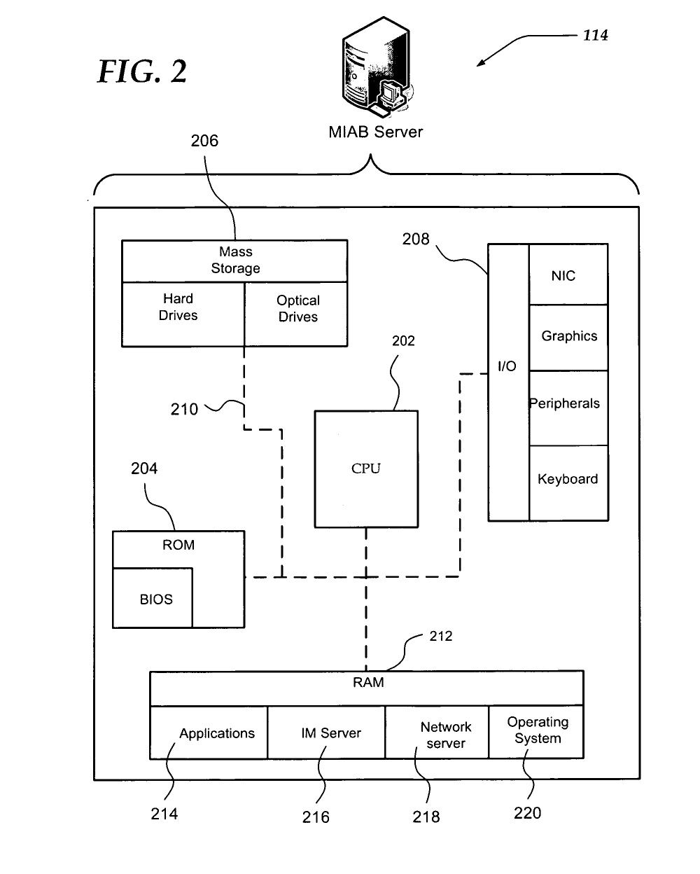

FIG. 2 shows one embodiment of a network device that can be used as MIAB Server 114. The network device includes central processing unit 202, input/output interface 208, ROM 204, RAM 212 and mass storage device 206. The various components are interconnected by bus 210. ROM 204 may include a Basic Input/Output System (BIOS) for controlling the low level operation of the network device. Ram 212 can contain various operating programs such as applications 214, Instant Message server 216, network server application 218 and operating system 220. Applications 214 can include the programs for implementing the current invention. For example, the applications in conjunction with network server 218 can receive the messages sent by the user, calculate and store the progress of the virtual bottle within the waterways of the geographic area, and determine when the bottle is sufficiently close to a second user such that the second user may be provided with the opportunity to read the message in the bottle.

The network device of FIG. 2 may also contain mass storage 206 which can be hard drives, optical drives, memory chips or similar devices for storing large quantities of data in non-volatile memory. Mass storage 206 may also store other program code and data. One or more applications 214 may be stored in mass storage 206 and then run within the environment of operating system 220.

The network device communicates through Input/Output device 208. Input/Output device 208 can constitute a number of separate devices. For instance, it may contain a network interface card, graphics card, peripheral controllers and the like. The server may also have a monitor and keyboard. The network device can communicate with a network, such as Internet/Local Area Network/Wide Area Network 108, through a network interface card using various communication protocols including TCP/IP protocol.

The invention can be implemented in several different ways. For example, the invention can be implemented through a traditional client server arrangement or a peer to peer network architecture. The application program can be implemented in client devices, network devices or any combination of various devices.

### General Operation

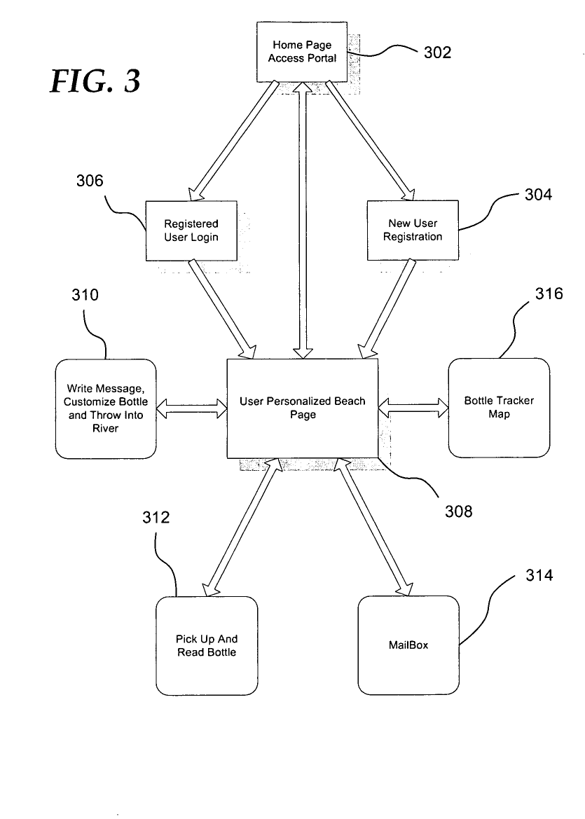

The general operation of one embodiment of the invention will be described with respect to FIGS. 3 through 12. This description is not intended to be limiting but only exemplary.

FIG. 3 shows the relationship between various components of the communication system, which may be implemented by, for example, MIAB Server 114. A user gains access to the system by entering the Uniform Resource Locator (URL) or the like into a web browser application running on a client device such as client devices 102, 104. For example, the user could enter http://www.babybottlepop.com into their web browser which provides the user with access to home page access portal 302.

The user is provided with two ways into the communication system from home page access portal 302. If the user is new to the system, then they perform the steps in New User Registration 304. If the user is already registered, then the user performs the steps within registered user login 306. After registration, the user is presented with user personalized beach page 308. This is the location from which the user can access the various different activities provided by the system. For example, the user can chose to write messages as shown in box 310, pick up and read bottle messages as shown in box 312, read incoming mail in box 314 and track the location of existing bottles sent through the communication system in box 316.

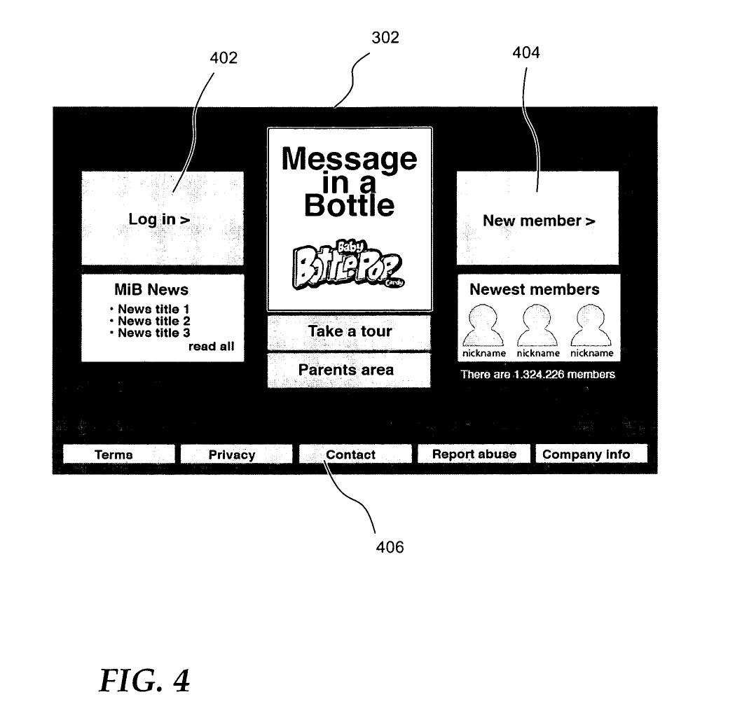

An example of home page access portal 302 is shown in FIG. 4. Selection of log-in option 402 would bring the user to the steps within registered user login 306. Selection of new member option 404 would bring the user to the steps for new user registration 304. The user is also able to engage in various other activities from this location, including such things as take a tour of the website, find out information about the company, contact a representative about the website, and various other activities not directly related to using the communication system.

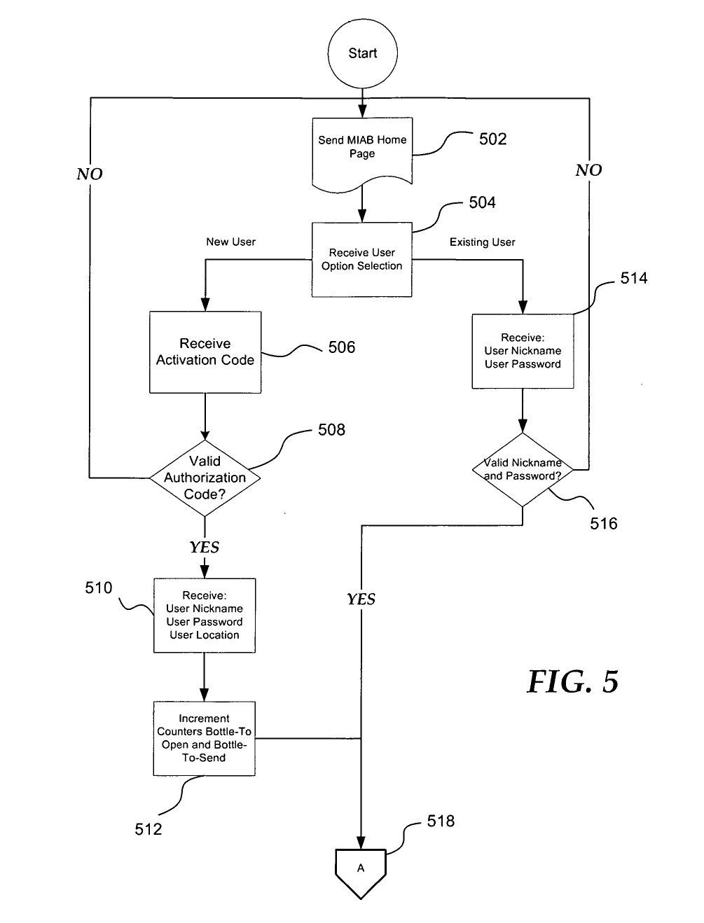

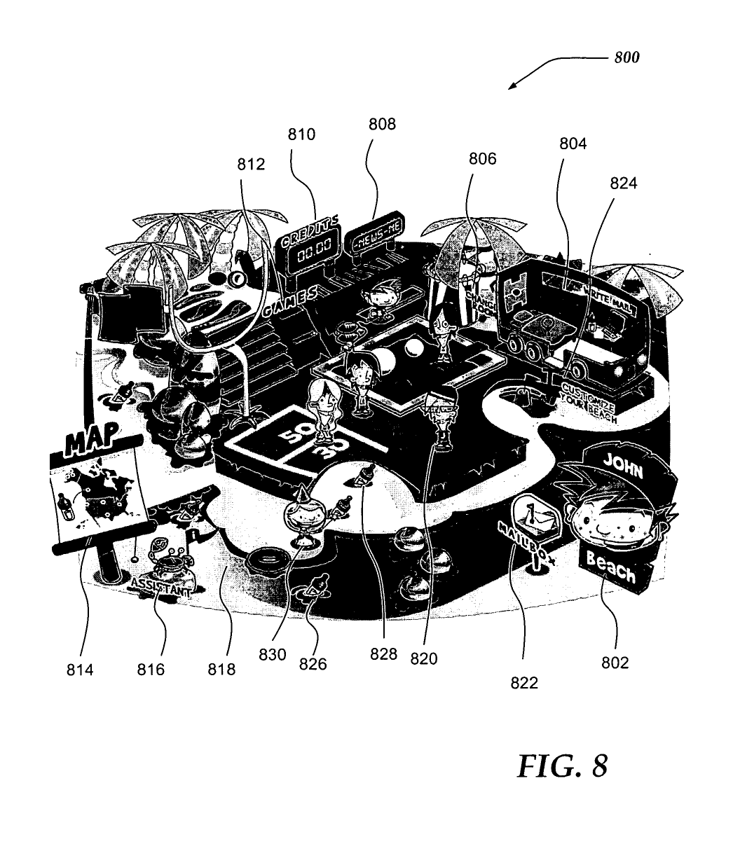

The registration process flow is shown in FIG. 5. On accessing the website, the user is provided with the MIAB home page access portal (an example of which is shown in FIG. 4) at block 502. The user then selects one of the options on the MIAB home page access portal, for example by putting the cursor over the selection and clicking on it. If the user is an existing user and selects registered user login, the user enters their user nickname and user password at block 514 which is received, for example, by the MIAB server. The user nickname and password are compared against existing authorized user profiles at block 516. If valid, then the user is brought to user personalized beach page, an example of which is shown in FIG. 8. If the user nickname and/or password are not valid, then the user is sent back to the MIAB home page access portal. If the user chooses new user registration, then the user must enter an activation code at block 506. The activation code is compared against a list of authorized activation codes or some other method of verification at block 508. If the activation code is not valid, then the user is sent the MIAB home page access portal. If the activation code is valid, then the user is prompted to enter a user nickname, user password and other information such as the user's location at block 510. The system then increments two different counters, the bottle-to-open counter and the bottle-to-send counter at block 512. Thereafter, the user is brought to the user personalized beach page.

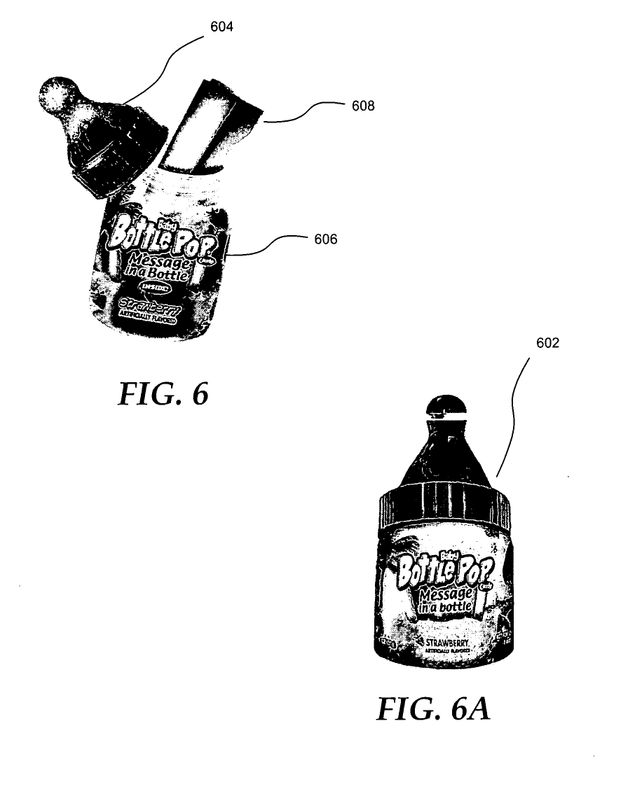

An activation code can be provided in several different ways. In one embodiment, the activation code is included within a consumer product as shown in FIGS. 6 and 6A. Consumer product 602 is a confectionary product designed to appear as a miniature baby bottle. Nipple 604 may be made of a hard candy and may be removably fastened to bottle 606. Bottle 606 may contain within it other types of confectionary products, such as a flavored powder confectionary, and can take forms other than a baby bottle. An activation code may be imprinted on food safe material 608 and sealed within the bottle. A consumer may obtain the activation code by purchasing the product and unsealing the container. In another embodiment, the activation code may be purchased on-line, provided as a part of a promotional campaign or through other means.

Once the user completes the registration process, they may be provided with a page such as, as just one example, that shown in FIG. 8. FIG. 8 shows stylized representations of the various activities that the user can engage in when using the communication system. In one embodiment, this page is customizable by the user. For instance, the user can select different themes for the look of the page such as a sports theme, fairytale theme, far west theme, hip-hop theme, outer space theme or the like. As an example of a fairytale theme, the background would have castle walls, a moat, a small tower, a medieval tent and a wooden painted sign. The different features may be the access points to the various activities that the user may access. The scene could also be changed by adding or removing different items or decorations. In the example of FIG. 8, to change the scene, the user would select customize your beach 824.

A user can chose to write mail by selecting feature 804, read mail by selecting feature 822, review the number of accumulated “rivermiles” (miles traveled by the user's bottles or earned by the user) which is displayed in feature 810, view the progress of existing bottles by selecting feature 814, access a help menu by selecting feature 816, and play games for rivermiles by selecting feature 812. In one embodiment of the invention, the user is provided with the opportunity to create a customized avatar. This may be done during registration or even afterwards. The user can pick such things as the gender of the avatar, hair color, skin color, clothing and the like. The avatar 802 can be shown on user personalized beach page 800. Alternatively, an avatar may be shown as a more complete figure elsewhere on the page. The look of the avatar can also be theme based in connection with the consumer product 602. As an example relating to the Baby Bottle Pop consumer product, the avatars can have a “baby” theme. If a western theme is used, the avatar can be dressed in a cowboy hat and shirt, but have a diaper instead of pants. Alternatively, the avatar can have baby-like features to it. The avatars of the user's bottlemates (other user's that were met because they read messages from the user, or other users that the user met because the user read their messages) that are currently on-line can also by shown on user personalized beach page 800 as shown by avatar 820. The appearance of the avatar can be changed by the user by selecting feature 806.

After the user writes a message that is placed within a bottle, user personalized beach page 800 can be changed to show that the bottle is being or has been placed in waterway 818. The bottle may be shown to leave the page, simulating a bottle floating away. This can be accomplished through animation of a bottle on the page that moves off of the screen along the waterway. User personalized beach page 800 can also be used to access messages sent by other users. These can be shown as, for example, bottles 826 or 828. These bottles, in this example, are unopened and the user does not know about the contents of the bottles. The user has the option of “picking” up and opening any of these bottles as set forth in more detail below.

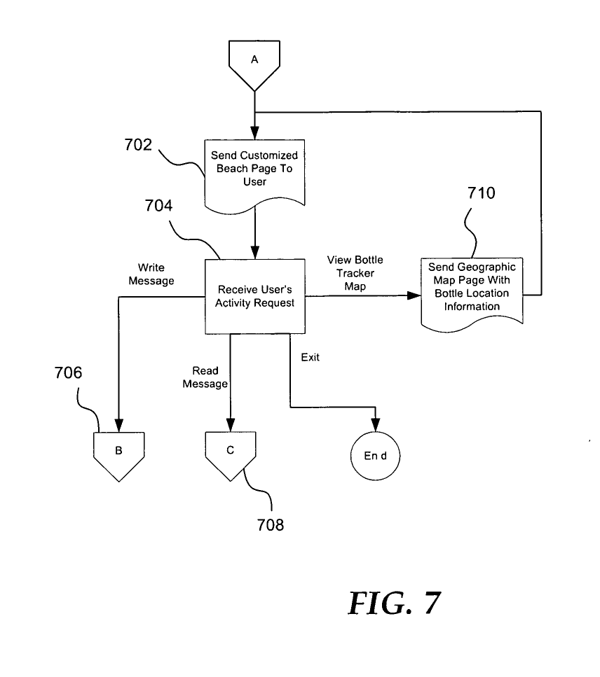

The flow chart for the various selections within user personalized beach page 800 are shown in FIG. 7. The user is sent the user customized beach page in block 702. The user then selects from the various activities in block 704. In FIG. 7, only four options are shown. However, there may be many different possible selections for the user.

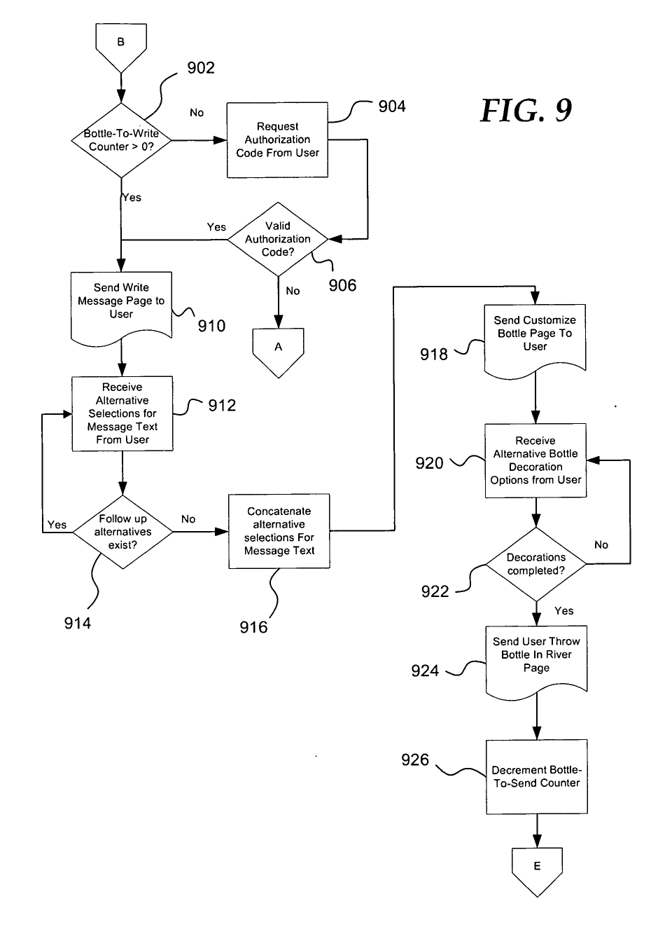

FIG. 9 shows the process flow for when a user chooses to write a message. After the user selects write a message of feature 804 in FIG. 8, the system checks bottle-to-write counter to determine whether the user has used up all of the user's allotted bottles as shown in block 902. In one embodiment of the system, the user may be provided with one bottle to write and one bottle to read for each valid authorization code that is entered. Thus, if the user has already used their allotted bottles, then they will be requested for an additional authorization code, which is subsequently validated pursuant to blocks 904 and 906. If a valid authorization code is entered, the user is then permitted to write a message as shown in block 910. If the authorization code is not valid, the user is brought back to user personalized beach page as shown in the flow diagram of FIG. 7. Any number of methods may be used to write a message. As one example, the message may be written using multi-choice scrolling bars. In the process flow of FIG. 9, the user is provided with alternative selections of possible messages until the message is complete. For example, a user can be asked to select from “I am”, “I hope” or “I would like”. Once the user selects one of the choices, for example “I am”, the user can be provided with additional selections such as “happy”, “excited” or “curious”. This can be done repetitively until a complete sentence is developed, as shown by blocks 912 and 914. This method permits control over the content of the messages, which is especially important for communication systems geared towards children. The message is generated by concatenating all of the selections in block 916.

Next, the user would have the option of customizing the appearance of the bottle and then having it thrown into the waterway. This is shown by blocks 918 through 924. The customizing of the bottle permits the user to add features to the bottle to distinguish it from other bottles. This personalization can be done to influence whether other users will select the bottle for reading. As an example, the bottle may be decorated in a sports theme, such that other user's interested in sports may be more likely to select the bottle for reading. In this embodiment, the bottles may all have a similar shape, and more specifically the shape of the actual consumer product. In one alternative embodiment, the bottles themselves can be selectable. In such an instance, the shape of the bottles may not correspond to that of the consumer product or there may be no corresponding consumer product. After the message is put into the communication system, the bottle-to-write counter is decremented at block 926.

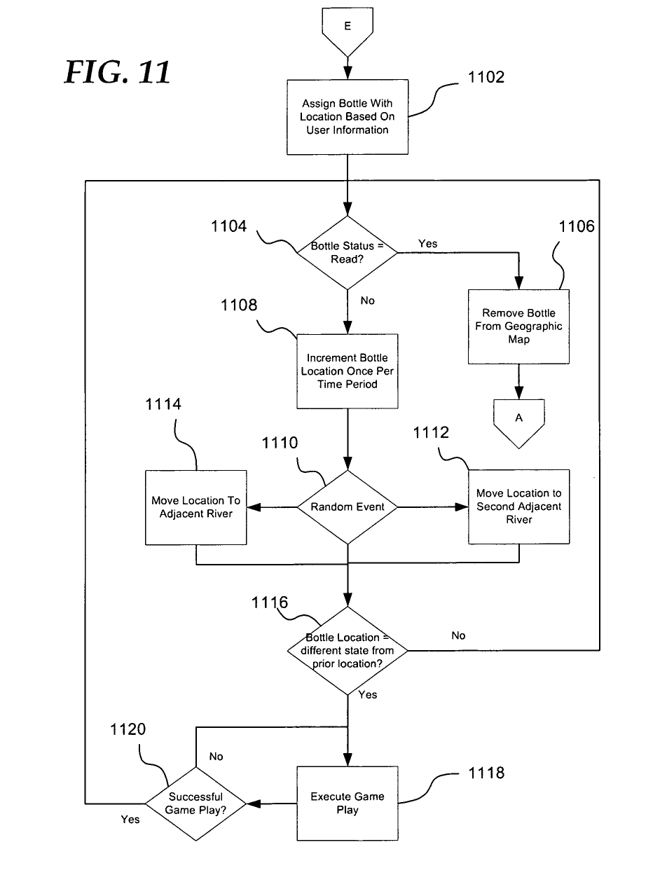

Once the user places a message into the virtual bottle and it is released into the waterway of the geographic map, the process flow for location of the bottle may follow that shown in FIG. 11. The message/bottle is assigned a starting location in block 1102. This location is typically based on the actual location of the user, which information may be obtained during the registration process. For example, the user can be required to enter their city or zip code, which would then be used to provide a location for the user personalized beach area and starting location for the message/bottle. However, other locations can be chosen or assigned to the user. Periodically, the bottle status will be determined as shown in block 1104. The bottle status may be “read” or “un-read”, or other similar indicators. The bottle status may be changed when a message/bottle is selected and read by another user. However, there may be other events that change the status of the bottle, such as elapse of time, current location or the like. The time that the bottle status is checked may be hourly, daily, weekly, each time the user logs on, a combination of these events or other events. If the bottle status is “read”, then the bottle is removed from the process flow. If the bottle status is “unread” or the like, then the location of the bottle will be changed within the virtual geographic area as shown in block 1108.

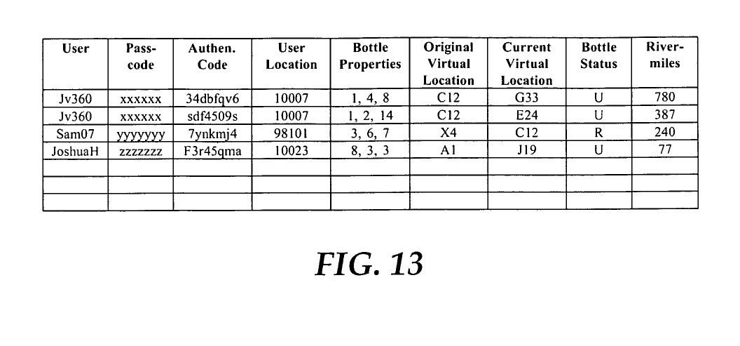

The data stored in memory by the system is shown in FIG. 13. Each user has an identifier such as a user name that can be used by the system to track the user each time they log onto the website. Each user could have an associated passcode that is required for entry to the website, which can provide protection from unauthorized use of the system. A user can have multiple bottles, as shown by the multiple entries for the first two lines of FIG. 13. The user can have multiple bottles within the virtual world, each having an associated authentication code and other tracking variables. The system can optionally store the user's location, such as the user's city or zip code. The system would then use this information to calculate and assign the user a location within the virtual world. The location of the user within the virtual world could be used as a starting point for each of the user's bottles. The system could also store the number of rivermiles that each bottle travels and the bottle properties. As an example, a user selects a theme for their bottle, such as a western or medieval theme, and provides various decorations or additions to their bottle to personalize it. The system can provide one of 10 different themes, one of a certain number of decorations, and so forth and so on. The user's choices can be stored in memory so that when the user's display is updated, the system would retrieve the stored selections from memory to generate the page (graphics) to be sent to the user. As shown in FIG. 13, user “Jv360” could have selected bottle property “1” (out of, for example, 10 different themes) which could correspond to selection of a western theme. The memory would also store the current status of the bottle, whether the bottle is read or unread. Other set variables can be stored in a similar manner, although not shown in FIG. 13. For example, the system could store the user's personalized beach page selections, details about the user's avatar and the like. The information stored by the system in memory would be used to provide a stylized representation of the location and progress of the user's bottles as set forth below.

One aspect of the invention is to provide a framework for incrementing or moving the virtual message through the geographic area. In FIG. 13, each bottle is assigned an original virtual location (which may be the same as the user) and a current virtual location. In one example of moving the message/bottle through the virtual world, each pathway can be assigned a letter and the length of the waterway could correspond to a series of numbers. For example, the Hudson River could be labeled as “A” and having a numerical length running from 1 to 50. A user at virtual location A1 would have the user's bottle start at original virtual location A1. The current virtual location would then be incremented periodically. For example, each day 1 is added to the numerical length. The next location would thus be A2, then A3 and so on. A conditional algorithm could be used when the end of the waterway length is reached. For example, when A50 is reached, the system would have rule-based algorithms which determine the next possible waterway. Thus, the system would conduct a conditional assessment such as: if current virtual location equals A50, then set current virtual location to B1. The same type of rules could be used for determining between two different choices of a branch in a waterway, when seemingly “random” events (as described below) occur, and the variations in rates of flow. The rules applied to the system can also be used to control general flow of all bottles within the system so that a certain number of bottles are presented to each user within a certain time period, and the bottles do not congregate in particular locations. The granularity of the system can be adjusted by increasing the relative “length” of each of the pathways.

The different waterways or pathways may also be interconnected such that the bottles will circulate and eventually end up back where they started, if not opened by another user. As a second example of controlling bottle flow, the geographic area may have a set of coordinates such as X,Y values. These values may be changed periodically according to mathematical formulas to, for example, approximate the movement of the message/bottle throughout the geographic area. The movement of messages/bottles may simulate the movement of an actual bottle within an actual waterway that is depicted by the geographic area. However, there may also be no association between the two. For instance, the directional flow of a river may or may not be taken into account in determining the flow of the message/bottle of the invention. There also may be connections between waterways that do not or could not exist in reality. The reason for this is that some areas within a geographic region may not contain adequate waterways or have unidirectional waterways that may not provide adequate circulation for the bottles.

To add variety to the movement of messages/bottles, random events may be set to occur as set forth in block 1110. Examples of random events are a seagull picking up and moving a message/bottle to another location, a storm causes greater movement of the bottle than normal, or a boat or ship interferes with the movement of the message/bottle. The message/bottle may be moved to an adjacent river as shown in block 1114, to a second adjacent river as shown in block 1112 or other locations within the geographic area. To provide further interest for the user, the user may be required to complete game play whenever the message/bottle reaches a state boundary as shown in blocks 1116, 1118 and 1120. In one embodiment, the message/bottle will not continue to travel until the game play is successfully concluded. The result of this requirement is that the user will be prompted to periodically log on to the website to see the status of their message/bottle. The status can be provided by pop-up windows on the user personalized beach page, or other means. The user can also be rewarded for successful game play with rewards, such as providing an additional bottle to read or send, which is done by incrementing the bottle-to-send or bottle-to-read counters. The user could also be provided additional rivermiles, which could be redeemed for awards, prizes or the like.

A user is presented with the option to read the bottle when the current virtual location of a bottle equals the user's virtual location, as shown by the match between the bottle of user “Sam07” and the location of user “Jv360” in FIG. 13.

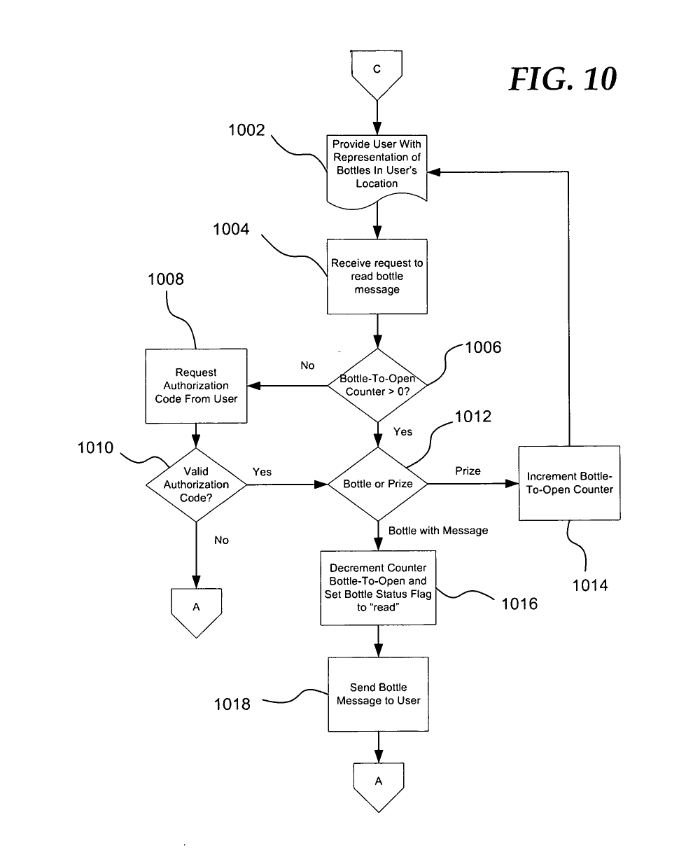

FIG. 10 shows the process flow for when a user chooses to read a message. The user is provided with a representation of the number of messages/bottles that they potentially can read at block 1002. The identification of such messages/bottles may be based on whether the current location of the message/bottle is the same as the location of the user personalized beach page, or that the bottle is within a predetermined virtual distance from the location of the user. Next, the bottle-to-open counter is checked to determine whether the user is entitled to open a bottle at block 1006. If the user is not entitled to open a bottle, then the user is prompted to enter an authorization code at block 1008. If not valid, the user is brought back to the user personalized beach page. If the code is valid or the user is entitled to open a bottle, the user may open a bottle. In one embodiment of the invention, the user can be presented with more than one bottle with a chance that one of the bottles has a prize in it. In the example of FIG. 10, one of the bottles may have an additional bottle to open as a prize, which would be processed by incrementing the bottle-to-open counter as shown in block 1014. If the bottle contains a message, in block 1016 the bottle-to-open counter is decremented, the bottle status is set to “read”, and the message is sent to the user in block 1018. At this point, the user may have the option of contacting the sender of the message. If the user chooses to send a message, then a process flow similar to that for writing a message described in FIG. 9 could be used. If the user declines to contact the sender, the user would be taken back to the user personalized beach page. In one embodiment of the invention, if the user declines to contact the sender, then the message could be re-inserted into the geographic map. In another embodiment of the invention, the message recipient may be required to contact the sender.

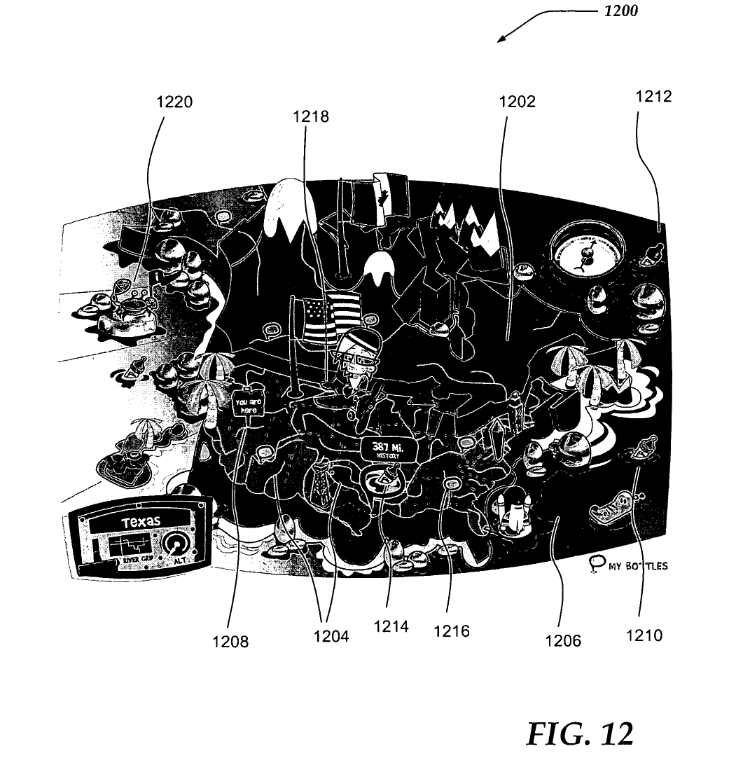

One of the options that a user may chose when at the user personalized home beach page is to view the progress of existing bottles by selecting feature 814 in FIG. 8. An example of the geographic map from which the progress of messages/bottles can be tracked is shown in FIG. 12. Geographic map page 1200 shows a geographical area that may have land masses 1202, oceans 1206, rivers 1204 and other geographic or fanciful features. The map may contain the user's location 1208, which may also correspond to the virtual location of the user personalized beach page. The user personalized beach page may be located at other places, and the location may be the choice of the user. The map may contain representations of the location of the user's various messages/bottles that remain unread, such as by unread bottle 1210 or 1212. In one embodiment, unread bottles may be represented in various ways, such as by feature 1216. Alternatively, the unread bottles may be shown as set forth by feature 1214, with a listing of the number of miles traveled by the bottle. A stylized representation of the user's avatar, designated as 1218, may be used to check on the status of the various unread bottles through the use of a fanciful device such as an aircraft.

The invention enables a user to a write message placed in a virtual bottle that is cast into a pathway within a virtual world to enable communication with others through the environment of the virtual world. The messages travel throughout various regions and can be picked up by another user. Therefore, the communication method appears random to the user. The user will then be able to further communicate with the user that picked up the bottle. The website is interactive and provides various activities. There can be other variations on this theme. For instance, roadways or airways can be used instead of waterways, different mediums can be used in place of bottles, and substitutions can be made for the geographic area such as different planets, different countries and the like.

What is claimed is:

1. A system for managing communications, comprising:
a plurality of client devices for sending and receiving communications over a network; and
a network device in communication with the plurality of client devices, and having a processor executing code that performs actions, including:
receiving a message from a user;
determining an initial position for the message within a virtual geographic region;
calculating a new position for the message within the virtual geographic region in accordance with movement of the message along a pathway within the virtual geographic region;
monitoring the new position for the message to determine whether the geographic position for the message is within a predetermined distance from a position of a second user within the virtual geographic region; and
permitting the second user to read the message when the monitoring step is satisfied.

2. The system of claim 1, wherein the network device is configured to perform further actions, including, prior to the step of receiving the message from the user:
receiving an authorization code from the user;
validating the authorization code; and
wherein the authorization code is obtained as a result of the purchase of a consumer product.

3. The system of claim 2, wherein the network device is configured to perform further actions, including:
generating a simulation of the consumer product within the virtual world.

4. The system of claim 1, wherein the network device is configured to perform further actions, including:
enabling further communication between the first and second users after the second user exercises the option of reading the message.

5. The system of claim 1, wherein the network device is configured to perform further actions, including:
selectively providing the user with rewards for participating in use of the communication system based on a tested criteria.

6. A method for managing a communication system through a network, comprising:
creating a representation of a geographic region that contains a location of a first user and travel pathways;
receiving a message from the first user;
generating a present location of the message within the geographic region based on the travel of the message along one of the travel pathways from the location of the first user;
assigning a second user with a location within the geographic region;
determining whether the present location of the message within the geographic region is within a predetermined distance from the location of the second user within the geographic region;
providing the second user with the option of reading the message when the present location of the message is within the predetermined distance from the location of the second user.

7. The method for managing a communication system through the network of claim 6, further comprising:
receiving an authorization code from the user;
validating the authorization code; and
wherein the authorization code is obtained as a result of the purchase of a consumer product.

8. The method for managing a virtual world communication system through the network of claim 7, further comprising:
providing the first user with a virtual representation of the consumer product.

9. The method for managing a virtual world communication system through the network of claim 6, further comprising:
enabling further communication between the first and second users after the second user exercises the option of reading the message.

10. The method for managing a virtual world communication system through the network of claim 6, wherein the location of the message is subject to random events that change the location of the message.

11. A method for managing a virtual world communication system through a network, comprising:
providing a first user with a first page having a selectable option of writing messages to be sent within the communication system;
receiving a message from the first user resulting from the selectable option of writing messages to be sent within the communication system;
generating a representation of a bottle to contain the message;
generating a present location of the bottle containing the message within a virtual geographic region based on travel at a certain rate of the bottle through one or more pathways within the virtual geographic region;
providing a second user with a second page having the selectable option of reading messages sent within the virtual world communication system;
permitting the second user to read the message when the location of the bottle containing the message within the virtual geographic region is within a predetermined distance from the location of the second user within the virtual geographic region.

12. The method for managing a virtual world communication system through the network of claim 11, further comprising:
receiving an authorization code from the user;
validating the authorization code; and
wherein the authorization code is obtained as a result of the purchase of a consumer product and the validation occurs before the step of providing a location of the bottle containing the message within a geographic region.

13. The method for managing a virtual world communication system through the network of claim 11, further comprising:
providing the first user with a virtual representation of the consumer product.

14. The method for managing a virtual world communication system through the network of claim 11, further comprising:
enabling further communication between the first and second users after the message is within a predetermined distance from the location of the second user within the geographic region and the second user exercises the option of reading the message.
